(19) United States
(12) Patent Application Publication
(10) Pub. No.: US 2007/0274085 A1
(43) Pub. Date: Nov. 29, 2007

(54) ILLUMINATED DISPLAY SYSTEM FOR VEHICLE WHEELS

(76) Inventor: Terrance Hampton, Jacksonville, FL (US)

Correspondence Address: MARK YOUNG, P.A., 12086 FORT CAROLINE ROAD, UNIT 202, JACKSONVILLE, FL, 32225, US

(21) Appl. No.: 11/754,259

(22) Filed: May 25, 2007

Related U.S. Application Data
(60) Provisional application No. 60/803,235, filed on May 25, 2006.

(51) Int. Cl. B60Q 1/26

(52) U.S. Cl. 362/500

(57) ABSTRACT

A light display device for a vehicle wheel includes an array of lighting elements (e.g., LEDs) and a microprocessor controlled circuit configured to selectively illuminate the lighting elements according to pre-stored lighting data to create perceptible alphanumeric characters and/or graphical images while the wheel rotates and for a determined time period thereafter. One or more sensors determine if the wheel is rotating, the rotational speed and whether daylight is present to illuminate the lighting elements on when the wheel is rotating in darkness. The device is configured for mounting to a rim such that the with the array of lighting elements being mounted to the backside of the rim positioned proximate to openings in the rim.

### RELATED APPLICATION

This application claims the benefit of priority of U.S. provisional application 60/803,235, filed May 25, 2006, the entire contents of which are incorporated herein by this reference.

### FIELD OF THE INVENTION

The invention relates to lights for vehicles and, more particularly, to a light assembly configured for installation on wheels of a vehicle and adapted to controllably illuminate lights positioned behind decorative cutouts and openings in the rim and rotating therewith, thereby creating consistently perceptible illuminated images.

### BACKGROUND

Lights have long been used on vehicles to signal turning, stopping and hazards, and to illuminate roadways. In recent years, ornamental lights have become popular. Such aesthetic lighting may include lights around a license plate, under a vehicle, inside a front grill, on antennas, and the like. Typically, such lights illuminate steadily or blink according to a determined frequency when activated. While such lighting arguably improves the appearance of a vehicle, it does not enable controllable illumination behind decorative cut-outs and openings in the rim and thereby create perceptible illuminated images.

A demand exists for innovative displays of various types of information and designs on vehicles. Widespread exposure of vehicles to the public provides an excellent opportunity to display a message, a favorite team's logo, a popular message, a name, a graphic image, an advertisement or the like (collectively, “indicia”). Vehicle wheels provide a good conspicuous location for displaying indicia on the vehicle. However, to be effective, the indicia should preferably be steadily illuminated so that onlookers may easily recognize it, even in night-time conditions.

Some prior attempts to illuminate rims have involved one or more stationary lights positioned behind a rim. The problem with such an approach is that the brightness of the light passing through apertures in the rim varies considerably. As an aperture aligns with the light, the brightness is at a maximum. As the aperture moves away from the light, the brightness decreases, until the aperture is dark or only faintly lit. The result is a flickering, inconsistently lit, strobe-like display. If the vehicle comes to a rest with the aperture away from the light, the aperture may be completely imperceptible at night.

Prior attempts to provide lights that rotate with a rim have involved rotatable electrical contact assemblies (e.g., a commutator). While such devices are useful for electrically coupling a rotating structure to a fixed structure, they suffer shortcomings. The assemblies tend to be complex and susceptible to failure. Over time, mechanical wear and tear, corrosion and soiling interfere with proper performance, resulting in an unreliable and annoyingly noisy structure.

As a consequence of the foregoing, there exists a longstanding need for a new and improved illuminated display system for vehicle wheels. The system should controllably activate lights in a manner to illuminate indicia intelligible to onlookers while the wheels rotate. Additionally, the system should be lightweight, relatively easy to use and easy to maintain. Furthermore, the system should be adaptable for mounting to wheels in various convenient manners.

### SUMMARY OF THE INVENTION

To overcome one or more of the problems and fulfill one or more of the needs as set forth above, in one aspect of an exemplary embodiment of the invention a light display device for a vehicle wheel includes an array of lighting elements (e.g., LEDs) and a microprocessor controlled circuit configured to selectively illuminate the lighting elements. One or more sensors determine if the wheel is rotating and whether daylight is present to illuminate the lighting elements only when the wheel is rotating and for a determined amount of time after rotation ceases, and only in darkness. The device is configured for mounting to wheel hub or integration into the rim of a wheel with the lighting elements being positioned behind the rim.

In an exemplary implementation, a wheel-mountable display device for a vehicle wheel having an inboard and outboard side and at least one aperture according to principles of the invention is provided. The device including at least one lighting element, an attachment for attaching the lighting element to the inboard side of the wheel adjacent to the aperture, a power supply, and a lighting circuit operably coupled to the power supply and the lighting element. The lighting circuit is configured to illuminate the lighting element to create a perceptible illuminated display. A wheel attachable housing, including a means for attachment of the housing to the wheel, contains the lighting circuit and power supply. A rotation sensor operably coupled to the lighting circuit produces wheel rotation signals. The lighting circuit is configured to illuminate the lighting element to create a perceptible illuminated display when wheel rotation signals are produced and for a determined period of time after production of wheel rotation signals cease. A photosensor operably coupled to the lighting circuit produces daylight signals. The lighting circuit is configured to illuminate the lighting element to create a perceptible illuminated display when daylight signals are not produced, i.e., when wheel rotation signals are produced and for a determined period of time after production of wheel rotation signals cease, if daylight signals are not produced. The power supply includes a rechargable battery, and the wheel-mountable display device further includes a photovoltaic charger operably coupled to the battery and configured to produce recharging current and supply the recharging current to the battery. The photovoltaic charger includes at least one photovoltaic cell and a recharging management circuit configured to detect a recharged condition of the battery and further configured to cease supplying recharging current to the battery when a recharged condition is detected. The aperture includes at least one alphanumeric character, which may comprise a message. The lighting circuit may include a microcontroller. The at least one lighting element may include at least one light emitting diode. The lighting circuit may also include a memory module, an input port and/or an input switch operably coupled to the lighting circuit. A status display operably coupled to the lighting circuit may also be provided.

### BRIEF DESCRIPTION OF THE DRAWINGS

The foregoing and other aspects, objects, features and advantages of the invention will become better understood with reference to the following description, appended claims, and accompanying drawings, where:

The foregoing and other aspects, objects, features and advantages of the invention will become better understood with reference to the following description, appended claims, and accompanying drawings, where:

FIG. 1 is a plan view of an exemplary conventional wheel comprised of a tire mounted to a rim and a display device mounted to the rim according to principles of the invention;

FIG. 2 is a high level block diagram of an exemplary circuit for an illuminated display device according to principles of the invention;

FIG. 3 is an perspective view of an exemplary illuminated light display device configured for mounting to a wheel according to principles of the invention;

FIG. 4 is a perspective view of an exemplary light mounting device configured for mounting a light to the back of a wheel according to principles of the invention; and

FIG. 5 is a plan view of another exemplary conventional wheel comprised of a tire mounted to a rim and a display device mounted to the rim according to principles of the invention;

FIG. 6 is a plan view of another exemplary conventional wheel comprised of a tire mounted to a rim and a display device mounted to the rim according to principles of the invention; and

FIG. 7 is a plan view of another exemplary conventional wheel comprised of a tire mounted to a rim and a display device mounted to the rim according to principles of the invention; and

FIG. 8 is a plan view of another exemplary conventional wheel comprised of a tire mounted to a rim and a display device mounted to the rim according to principles of the invention; and

FIG. 9 is a plan view of another exemplary conventional wheel comprised of a tire mounted to a rim and a display device mounted to the rim according to principles of the invention; and

FIGS. 10 through 15 are plan views of additional exemplary rims with cutouts in various arrangements according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the types of footwear, shapes, relative sizes, ornamental aspects or proportions shown in the figures.

### DETAILED DESCRIPTION

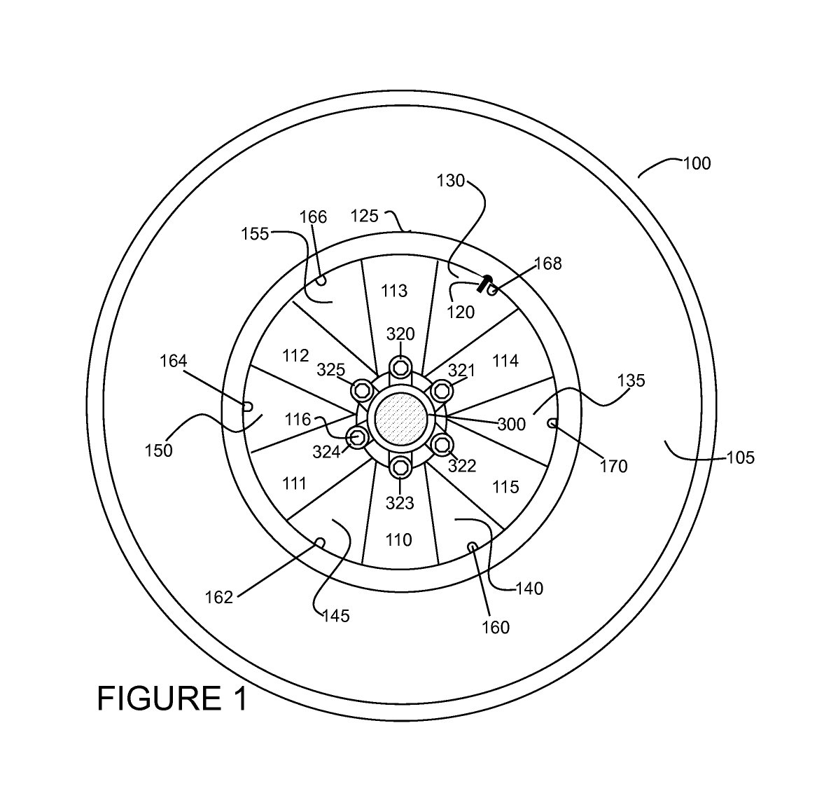

Referring to the Figures, in which like parts are indicated with the same reference numerals, various views of an exemplary rotating wheel-mounted system adapted to controllably illuminate lights positioned behind decorative cutouts and openings in the rim of a wheel, thereby creating consistently perceptible illuminated images, according to principles of the invention are shown. Referring first to FIG. 1, a conventional vehicle wheel 100 is conceptually shown. The wheel 100 includes a tire 105 mounted to an exemplary rim 125. The exemplary rim 125 includes a plurality of spokes 110-115 and an aperture for a tire valve 120. A plurality of lug nuts 116 are provided to secure a housing 300 to the wheel 100, and to secure the wheel 100 to the vehicle. The housing 300 contains components of an illuminated display system according to principles of the invention. Openings 130-155 are provided between the spokes 110-115. One or more light sources 160-170 are positioned behind the openings 130-155 so that light from the light sources 160-170 shines through the openings 130-155 when activated.

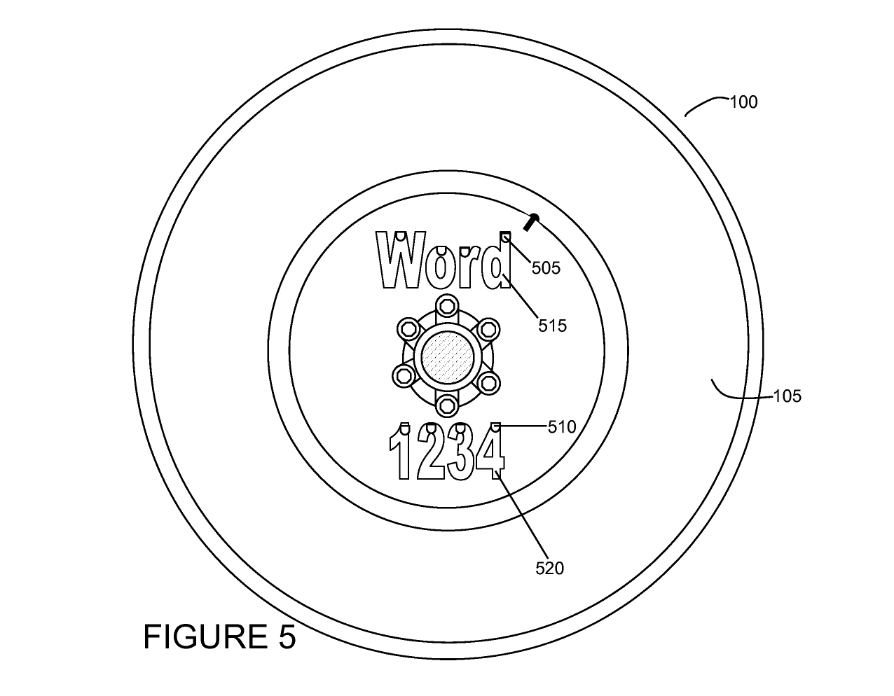

The wheel 100 is not limited to any particular ornamental design, except that one or more openings should be provided for backlighting to shine through. Other decorative wheel styles, with or without spokes 110-115, and with or without openings 110-115 as shown in FIG. 1, according to any design with at least one opening, may be utilized in accordance with the principles of the invention. The opening may be a geometric shape, the shape of an alphanumeric character or message, a logo, an ornamental design or any other shape. Illustratively, as shown in FIG. 5, openings in the rim may include one or more words 515 and numbers 520, with lights 505, 510 positioned proximate to the openings.

The housing 300 is not limited to being attached to the front (i.e., outwardly facing surface) of the wheel, or to being attached by wheel lugs; nor is the housing limited to a cylindrical or conical shape. A housing 300 according to principles of the invention may be attached to the wheel in any manner that provides secure attachment without interfering with operation of the wheel. Illustratively, the housing may be attached to the back of the wheel (e.g., behind a spoke 110), secured between the tire 105 and rim 125 at the interface thereof, or coupled to the tire in any other suitable manner using mechanical attachments, welds, adhesives or chemical bonding agents. Furthermore, any shape housing may be utilized, so long as the housing does not interfere with operation of the wheel.

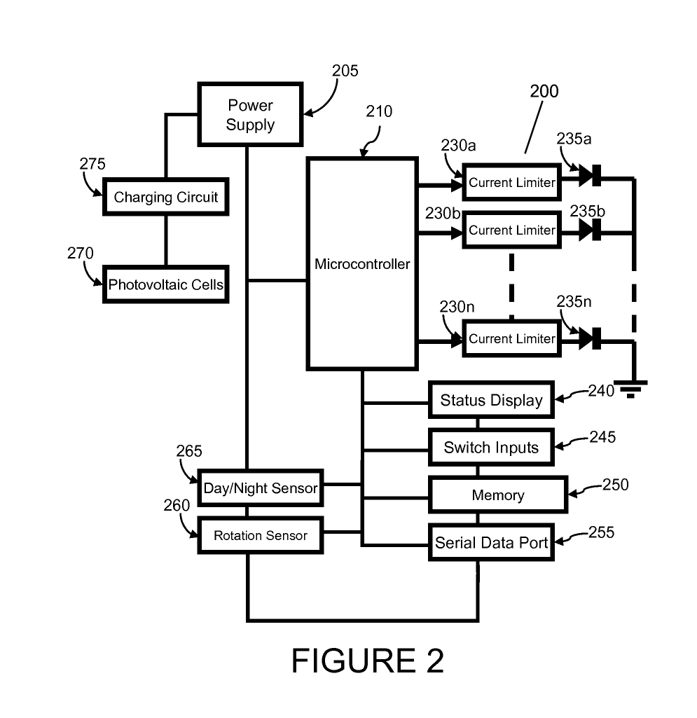

Referring now to FIG. 2, a high level block diagram of an exemplary circuit 200 for an illuminated display device according to principles of the invention is provided. The device controllably illuminates a plurality of lighting elements (e.g., LEDs) to provide backlighting shining through openings in the wheel for purposes of illuminating the openings, while the wheel 100 rotates, in dark ambient conditions, and for a determined amount of time after rotation ceases. As the plurality of LEDs move in a circular pattern, the LEDs are controllably illuminated in such a way that in a darkened background (e.g., during nighttime) the indicia is perceptible and intelligible. It will be obvious to those skilled in the art that other circuits and components can be used to produce a similar result.

A power supply 205 such as a disposable or rechargeable battery, a magneto-electric power generator or photovoltaic cells 270 with a rechargeable battery is provided. Thus, photovoltaic cells 270 may charge a battery 205 when sunlight is available. A charging circuit 275 may be provided to prevent overcharging and reverse drain. Alternatively, or in addition to photovoltaic recharging, a magneto-electric generator may charge a battery, or a large capacitor, as rotation of the wheel causes the device to move by a magnetic field produced by a strategically placed permanent or electromagnet. By way of example and not limitation, the magnet may be attached to a fender, brake caliper, or other structure that the device periodically passes by as the wheel rotates.

A microcontroller 210 controls illumination of light sources (e.g., LEDs) 160-170. Any compact device or combination of devices capable of controlling the illumination of LEDs according to data stored in memory may be utilized without departing from the scope of the invention. The microcontroller 210 may include an internal clock oscillator that provides a time base for all operations. It may also include internal memory which may store programming for the device and a table that determines when LEDs 160-170 should be illuminated during which time periods in order to generate an illuminated display as determined by programming. Illustratively, other devices that may be utilized in lieu of or in addition to microcontroller 210 include digital signal processors (DSP), Field Programmable Gate Arrays (FPGA), application-specific integrated circuits (ASIC), discrete gate logic, or other integrated circuits, hardware or firmware capable of controlling the illumination of LEDs according to data stored in memory.

In operation, the circuit 200 switches each LED when determined conditions are detected. In a preferred implementation, an LED is illuminated while the wheel is rotating in dark conditions (e.g., at nighttime) and for a determined period of time after rotation ceases. In another implementation, an LED is illuminated while the wheel is rotating, within a determined range of speeds, in dark conditions (e.g., at nighttime) and for a determined period of time after rotation ceases. When the LEDs are activated, one or more openings in the wheel are illuminated by the LEDs in a manner perceptible to onlookers.

Optionally, a photo-sensor (i.e., day/night sensor) 215 is provided to conserve energy by directing the microcontroller 210 to only illuminate the LEDs 160-170 when the background light is dim enough so the desired effect may be readily perceived. Illustratively, a photovoltaic cell may serve as the sensor 215, in which case it may also recharge the power supply 205 during daylight and allow activation of the LEDs during nighttime. Alternatively, for example, a photodiode, or some other electronic device responsive to the presence or absence of light, may serve as a photo-sensor 215.

An object of the invention is to conserve battery power by illuminating the light sources 160-170 when the vehicle is in use in dark (nighttime) conditions. A rotation sensor 220 detects when the vehicle wheel is rotating, and may also determine a rate of rotation. An optical, electromechanical, electromagnetic or some other type of rotation sensor 220 will detect rotation of the wheels, and produce a corresponding rotation signals. Optionally, the rotation sensor may also detect the speed of rotation, and generate corresponding signals.

The invention conserves battery power by illuminating the light sources 160-170 when the vehicle is in use in dark (nighttime) conditions. In daylight, when the illumination would be substantially imperceptible, illumination would waste battery power. The photo-sensor (i.e., day/night sensor) 215 directs the microcontroller 210 to only illuminate the LEDs 160-170 when the background light is dim enough so the desired effect may be readily perceived. During nighttime, when the vehicle is in use, the rotation sensor 220 will detect rotation of the wheels and produce a rotating signal. When the vehicle comes to a stop, the rotation sensor 220 will not detect rotation and the output signal will be adjusted accordingly. From the time the rotation sensor 220 detects that rotation has ceased, until a determined time thereafter, the microcontroller 210 will continue to cause the light source(s) 160-170 to illuminate. Thus, when a vehicle comes to a stop in traffic, at a red light, at a stop sign or in a parking space, for example, the light sources will continue to illuminate for a determined period of time (the “post-rotation time”), which may be a few seconds to several minutes. The post-rotation time may be varied depending upon sensed conditions, such as detected speed, duration of rotation, and user input. If the wheel has not resumed rotation after expiration of the post-rotation time, the illumination ceases to conserve battery power.

The current limiters 230a-230n protect the LEDs 160-170 from an over current condition and conserve battery power. Current limiters 230a-230n may be comprised of resistors that limit the current sourced by the microcontroller 210. Current limiters 230a-230n could be comprised of active electronic current control circuits or devices that are controlled by the microcontroller 210 output signal. There could be one or more Current limiters 230a-230n per LED 160-170 channel, depending upon the LED 160-170 configuration.

The LEDs 160-170 emit light under precise timing control in order to produce a desired illuminated display during determined conditions. A single LED may be provided per channel or line 330-355, or a plurality of LEDs may be provided in series and/or parallel configuration to work in unison. Those skilled in the art will appreciate that multi-colored (e.g., two, three or more colors) sets of colored (e.g., red, green, and blue) LEDs may be provided for each line 330-355, that when properly controlled would produce multi-colored displays.

An optional status display 240 provides a visual cue (e.g., a user interface) that facilitates user configuration of the device and supplies feedback to a user as to a display pattern that has been selected. The status display 240 is controlled by the microcontroller 210. By way of example and not limitation, the status display 240 may be comprised of a seven segment LED display module.

Switch inputs 245 may optionally be provided for a user to manually select indicia for display, and/or to input commands for the system. Illustratively, the switches 245 may include mechanically actuated switches. However, other types of switches may also be used, such as Hall Effect sensors stimulated by either a hand-held magnet or button press.

A removable or non-removable memory module 250 may also be provided to store or add pre-programmed sets of light patterns to a user selection database. Any type of portable, non-volatile user changeable memory module may be utilized.

An input port such as a serial data port 255 may also be provided to enable communication of data and settings from a digital programming device such as, but not limited to, a PC or laptop computer. This port could be an RS232 port, USB port, or any electrical or optical communications means.

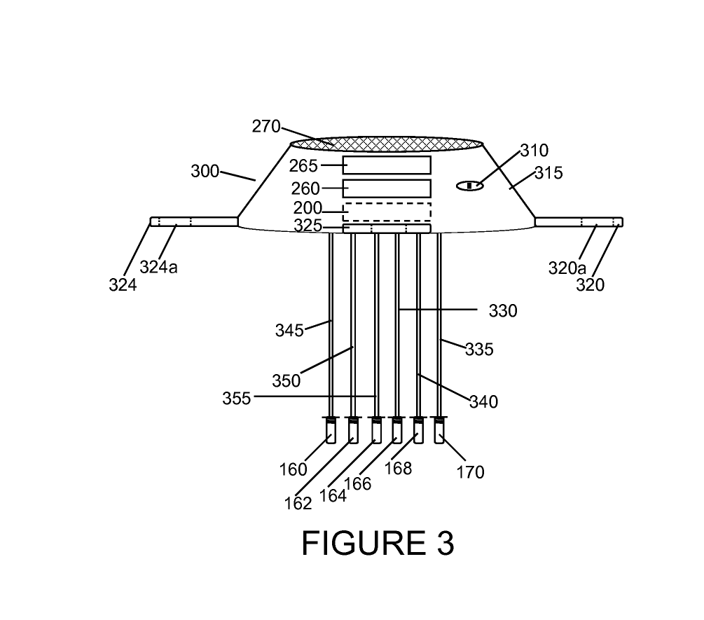

Referring now to FIG. 3 an embodiment of a housing for the invention will now be described. A device according to principles of the invention has numerous components that must be securely mounted to a wheel. These components act in combination to achieve the objectives of the invention as describe herein. The exemplary device 200 includes a protective housing 315 with one or more sensors 260, 265. A plurality of tabs 320-325 are provided to securely fasten the housing to the wheel using lugs. The exemplary tabs 320-325 include members with holes 320a-325a for receiving a lug. The arrangements of tabs 320-325 and holes 320a-325a is sized and shaped to fit within the space provided in the rim for receiving lug nuts and to hold the display device 300 against a rim. A lug nut secures the tabs to the lug. When the bracket is secured to the lug, the display device is secured against a rim. The mounting tabs may be an integral part of the display device or a separate component attached to the display device. An array of lighting elements (e.g., LEDs) 160-170 is provided for selective illumination. Switch inputs 245 may include one or more switches and, optionally, a visual (e.g., LCD or LED display) for user control of the device.

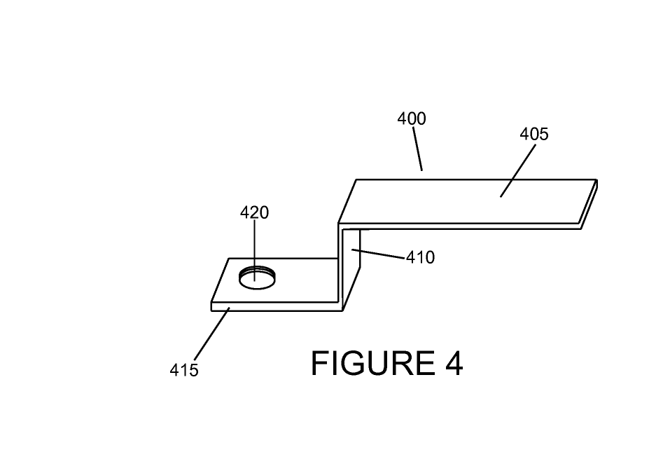

Referring now to FIG. 4, an exemplary light mounting bracket 400 is provided for securing a light source, e.g., LED, to the backside of a rim. The exemplary bracket includes a mounting arm 405, a perpendicular offset arm 410, and an engagement arm 415. The engagement arm 415 includes a threaded opening 420 or other means for securely receiving a light source, such as an LED with a threaded collar. The mounting arm 400 may be secured to the backside of a rim by chemical or mechanical fastening means, including, but not limited to, epoxy, adhesive, or welding. The mounting arm 400 should be positioned to direct the light source at an opening in the rim. The mounting arm may be malleable/deformable to allow adaptation for various wheel configurations.

Optionally, an exemplary display device according to principles of the invention may be provided in a kit with one or more counterbalancing weights to compensate for any rotational imbalance caused by mounting the display device to the wheel. The counterbalancing weight may be comprised of a weighted object, such as a conventional lead weight molded around a steel clip configured to be attached to a flange of the rim or wheel or a weight with an adhesive tape backing for attachment to the rim of the wheel. A backing strip may be removably attached to the adhesive backing of the tape to protect the tape. Instructions may be provided for selection, positioning and installing the counterbalancing weight to achieve proper balance of the wheel and tire in order to prevent vibrations which could otherwise occur at certain vehicle speeds.

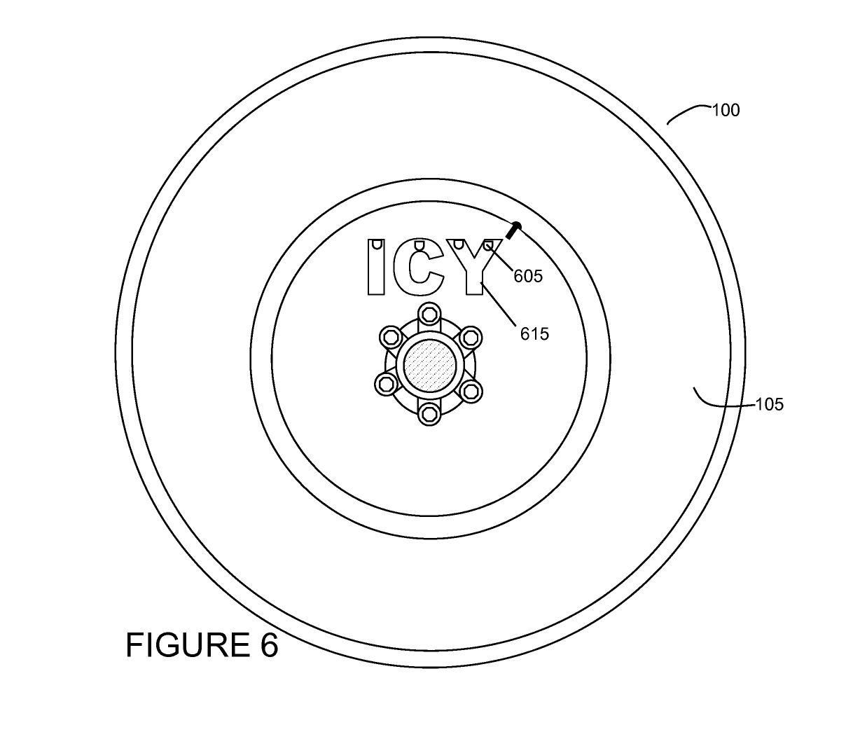

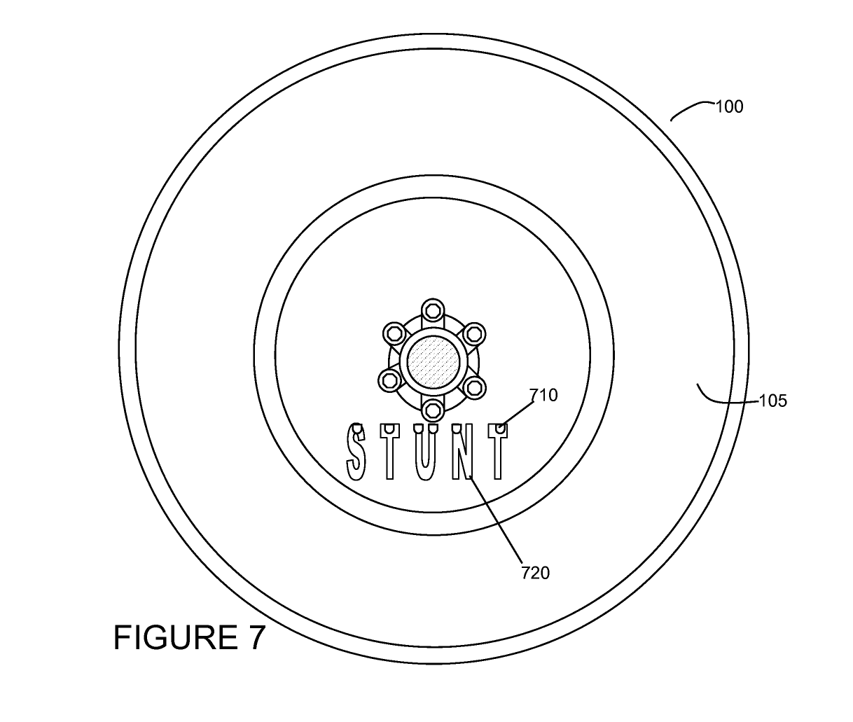

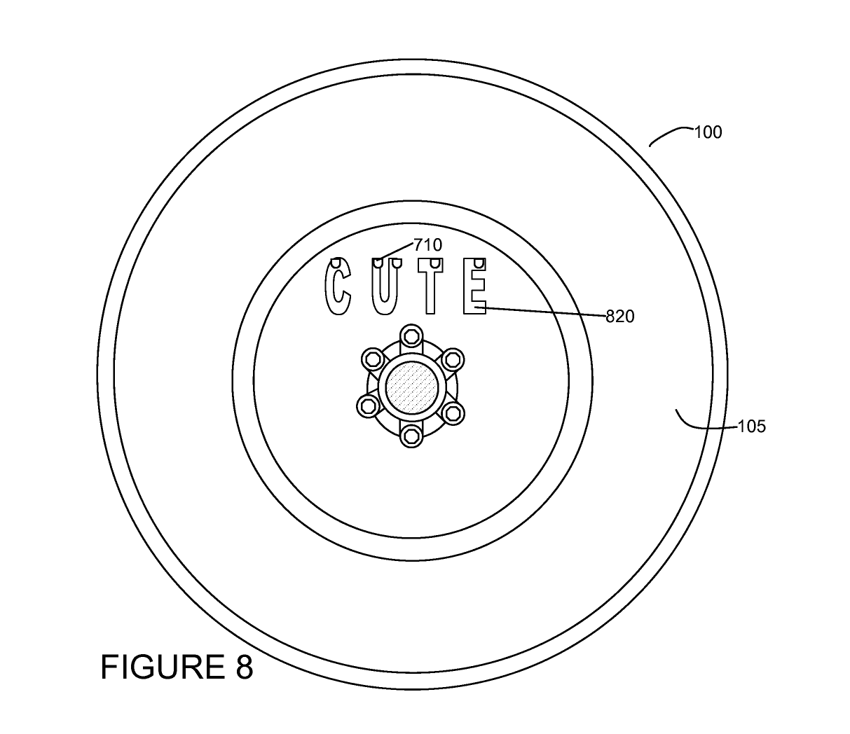

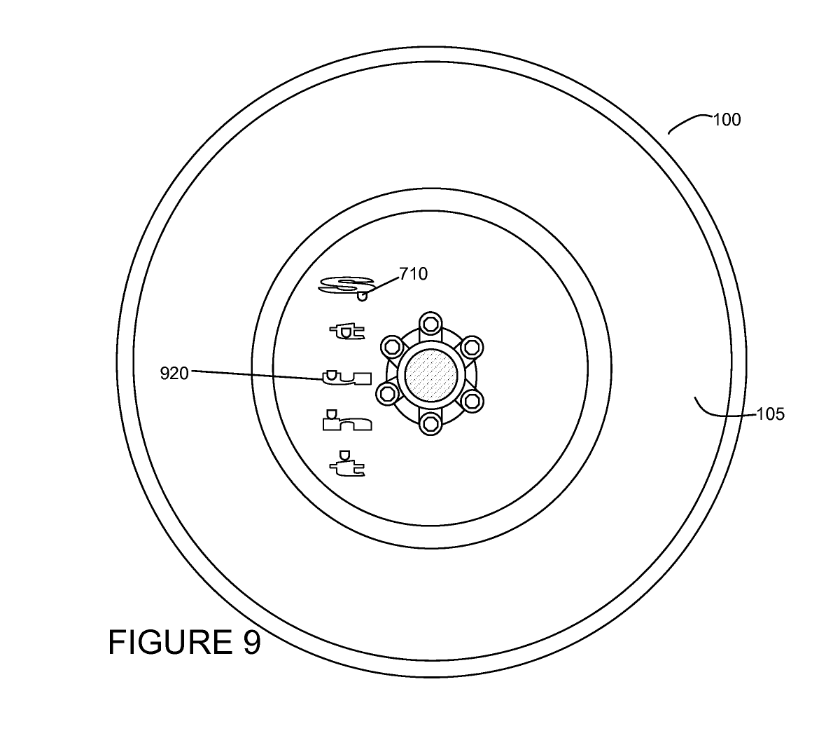

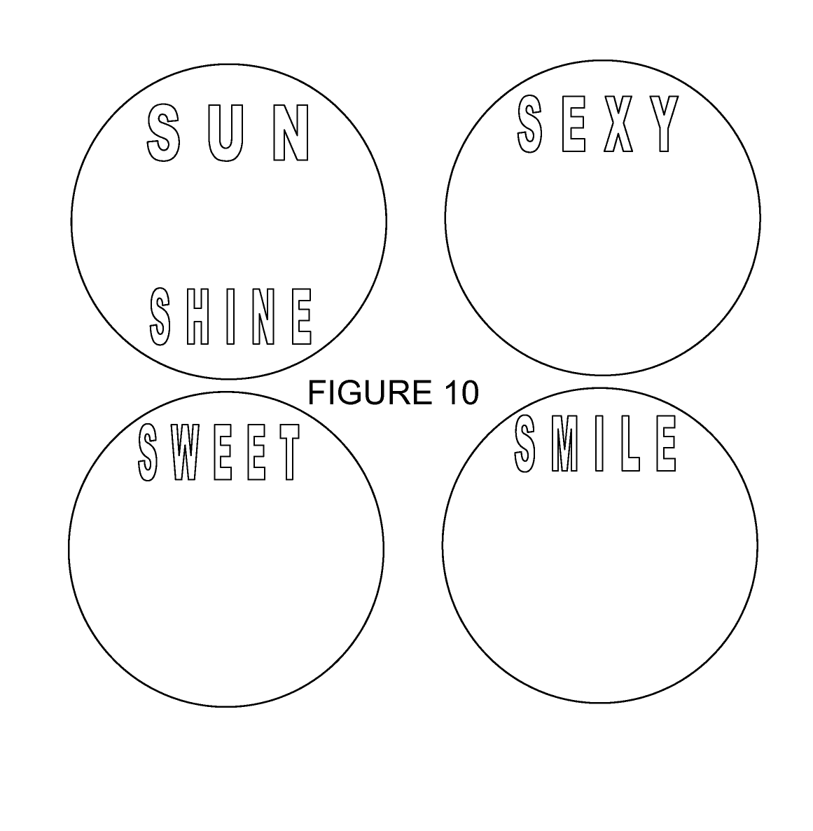

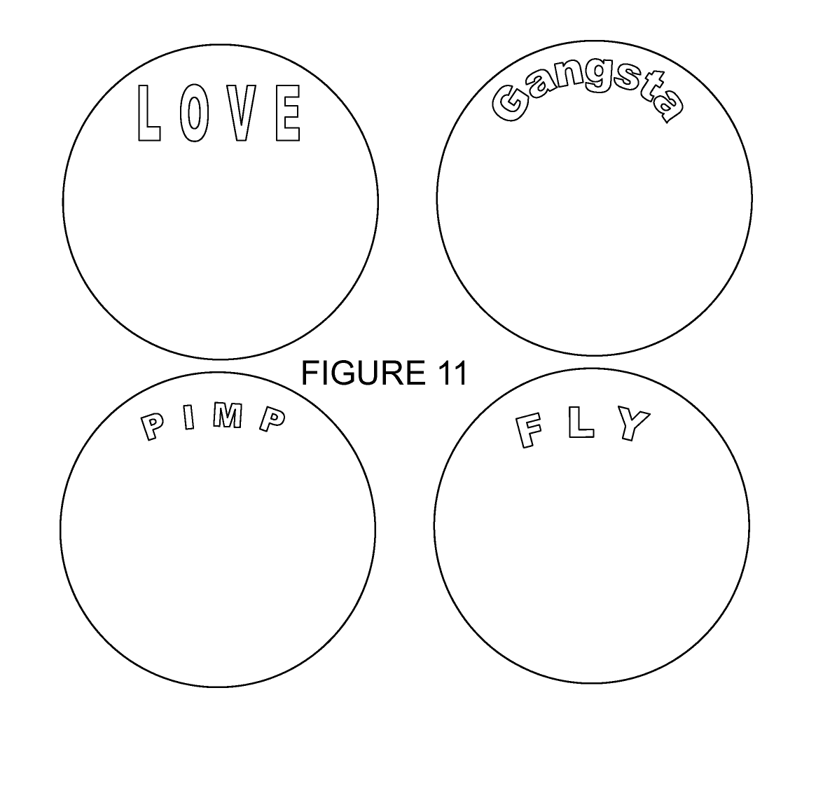

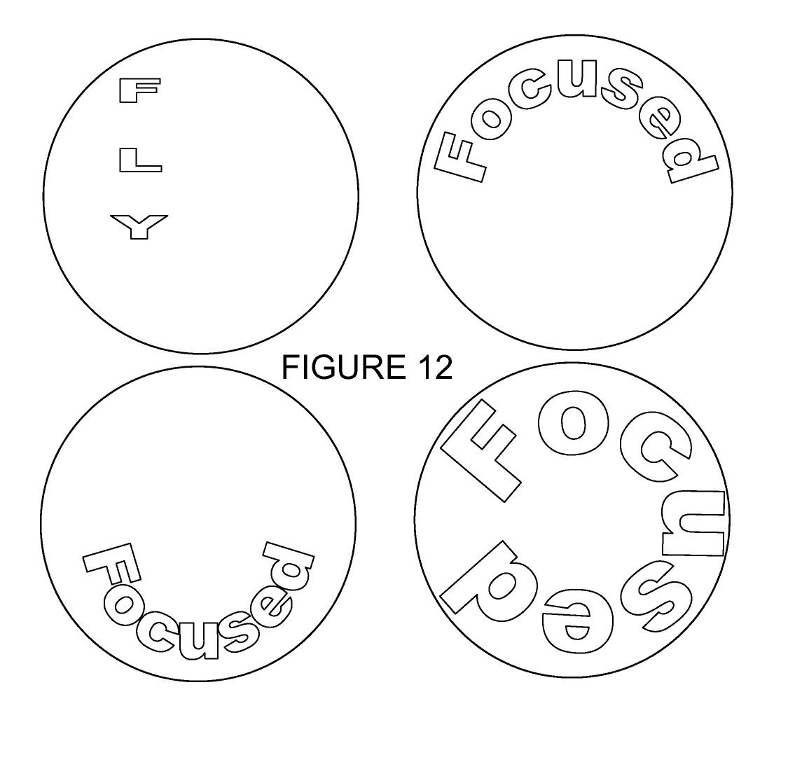

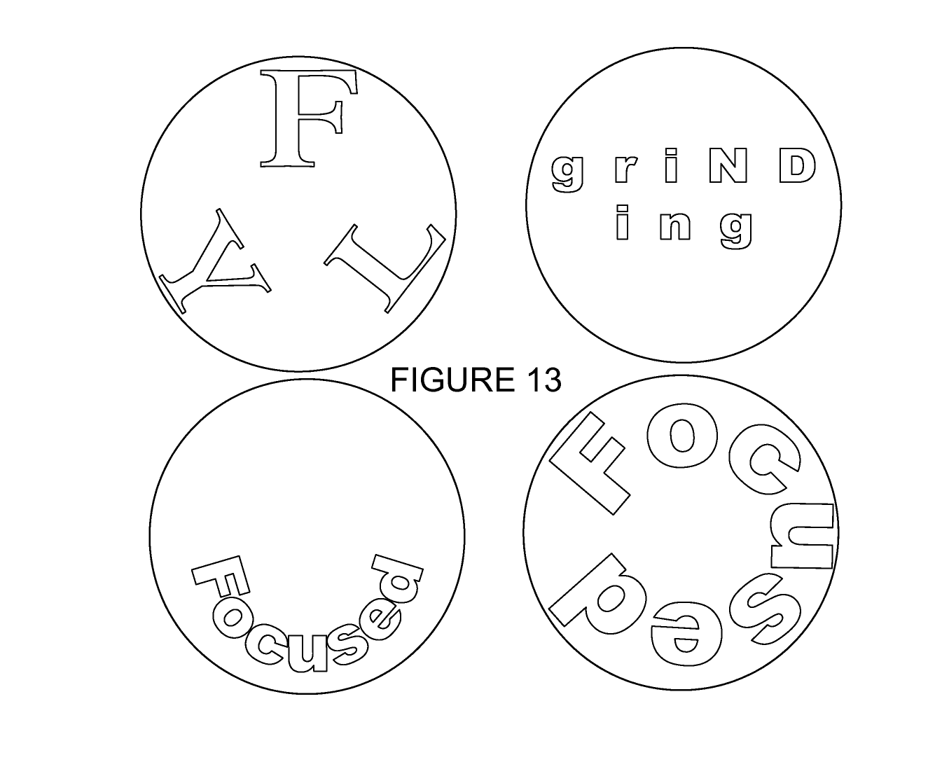

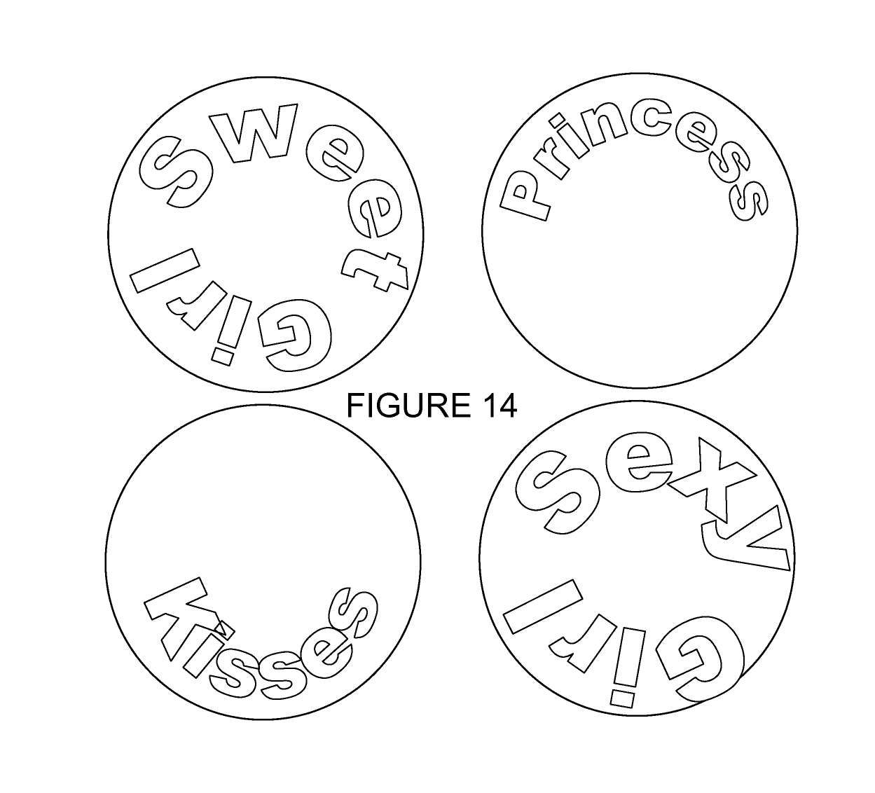

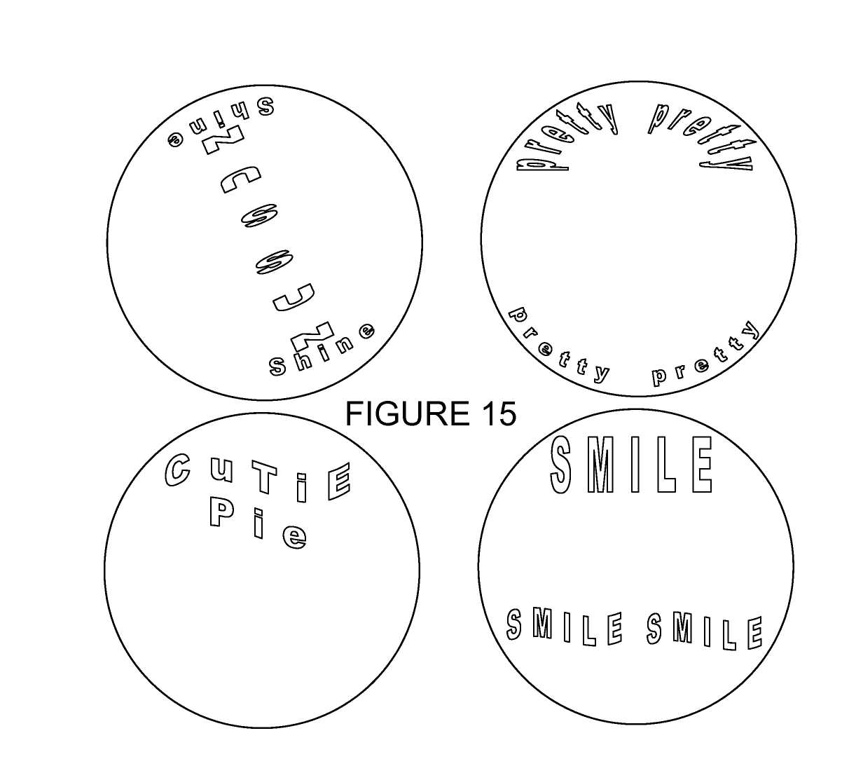

Illustratively, as shown in FIG. 5, openings in the rim may include one or more words 515 and numbers 520, with lights 505, 510 positioned proximate to the openings. The word(s) may comprise one or more popular sayings, names, slogans, messages, etc. . . . By way of example and not limitation, the slang word ICY 615 may be displayed on the rim 105 with light sources 605 behind one or more of the letters in the word, as shown in FIG. 6. As another example, the slang word STUNT 720 or CUTE 820 may be displayed on the rim 105 with light sources 710 behind one or more of the letters in the word, as shown in FIGS. 7 and 8. The wording 920 may be vertically arranged as in FIG. 9. However, the invention is not limited to such words. Instead, the principles of the invention may be applied to any word, alphanumeric character arrangement, design, logo or other subject matter that may be formed into a rim and through which light may pass. Such other wording may include SUN SHINE, SEXY, SWEET, SMILE, LOVE, GANGSTA, PIMP, FLY, FOCUSED and others as conceptually illustrated in the plan views of FIGS. 10-15, in any configuration, such as horizontal, vertical, concave, convex, scattered, diagonal, right-side up, upside down, etc. . . . In each case, the cutouts for the letters and/or other design elements would be arranged on the rim so as not to interfere with the functional aspects of the rim (e.g., the mounting lugs and the housing for the display device).

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A wheel-mountable display device for a vehicle wheel having an inboard and outboard side and at least one aperture, said device comprising at least one lighting element; an attachment for attaching the lighting element to the inboard side of the wheel adjacent to the aperture; a power supply; a lighting circuit operably coupled to said power supply and said lighting element; said lighting circuit being configured to illuminate said lighting element to create a perceptible illuminated display.

2. A wheel-mountable display device according to claim 1, further comprising a wheel attachable housing containing said lighting circuit and power supply.

3. A wheel-mountable display device according to claim 1, further comprising a wheel attachable housing containing said lighting circuit and power supply and including a means for attachment of the housing to the wheel.

4. A wheel-mountable display device according to claim 1, further comprising a wheel attachable housing containing said lighting circuit and power supply and including a plurality of clips for attachment of the housing to the wheel.

5. A wheel-mountable display device according to claim 1, further comprising a rotation sensor operably coupled to said lighting circuit and configured to produce wheel rotation signals; said lighting circuit being configured to illuminate said lighting element to create a perceptible illuminated display when wheel rotation signals are produced.

6. A wheel-mountable display device according to claim 1, further comprising a rotation sensor operably coupled to said lighting circuit and configured to produce wheel rotation signals; said lighting circuit being configured to illuminate said lighting element to create a perceptible illuminated display when wheel rotation signals are produced and for a determined period of time after production of wheel rotation signals cease.

7. A wheel-mountable display device according to claim 1, further comprising a photosensor operably coupled to said lighting circuit and configured to produce daylight signals; said lighting circuit being configured to illuminate said lighting element to create a perceptible illuminated display when daylight signals are not produced.

8. A wheel-mountable display device according to claim 1, further comprising a rotation sensor operably coupled to said lighting circuit and configured to produce wheel rotation signals; a photosensor operably coupled to said lighting circuit and configured to produce daylight signals; said lighting circuit being configured to illuminate said lighting element to create a perceptible illuminated display when wheel rotation signals are produced if daylight signals are not produced.

9. A wheel-mountable display device according to claim 1, further comprising a rotation sensor operably coupled to said lighting circuit and configured to produce wheel rotation signals; a photosensor operably coupled to said lighting circuit and configured to produce daylight signals; said lighting circuit being configured to illuminate said lighting element to create a perceptible illuminated display when wheel rotation signals are produced and for a determined period of time after production of wheel rotation signals cease, if daylight signals are not produced.

10. A wheel-mountable display device according to claim 1, wherein said power supply comprises a battery, and said wheel-mountable display device further comprises a photovoltaic charger operably coupled to said battery and configured to produce recharging current and supply said recharging current to said battery.

11. A wheel-mountable display device according to claim 1, wherein said power supply comprises a battery, and said wheel-mountable display device further comprises a photovoltaic charger operably coupled to said battery and configured to produce recharging current and supply said recharging current to said battery, and said photovoltaic charger further comprises at least one photovoltaic cell.

12. A wheel-mountable display device according to claim 1, wherein said power supply comprises a battery, and said wheel-mountable display device further comprises a photovoltaic charger operably coupled to said battery and configured to produce recharging current and supply said recharging current to said battery, and said photovoltaic charger further comprises at least one photovoltaic cell and a recharging management circuit configured to detect a recharged condition of the battery and further configured to cease supplying recharging current to said battery when a recharged condition is detected.

13. A wheel-mountable display device according to claim 1, wherein said aperture comprises at least one alphanumeric character.

14. A wheel-mountable display device according to claim 1, wherein said aperture comprises a message.

15. A wheel-mountable display device according to claim 1, wherein said lighting circuit comprises a microcontroller.

16. A wheel-mountable display device according to claim 1, wherein said at least one lighting element comprises at least one light emitting diode.

17. A wheel-mountable display device according to claim 1, wherein said lighting circuit comprises a microcontroller and a memory module.

18. A wheel-mountable display device according to claim 1, further comprising an input port operably coupled to said lighting circuit, said lighting circuit comprising a microcontroller and a memory module.

19. A wheel-mountable display device according to claim 1, further comprising at least one input switch operably coupled to said lighting circuit.

20. A wheel-mountable display device according to claim 1, further comprising a status display operably coupled to said lighting circuit.
